(19) United States
(12) Patent Application Publication
(10) Pub. No.: US 2020/0049292 A1
(43) Pub. Date: Feb. 13, 2020

(54) HYDRAULIC COUPLING DEVICES AND ASSEMBLIES

(71) Applicant: Caterpillar Inc., Deerfield, IL (US)

(72) Inventor: Bailey FERKEL, Menominee, MI (US)

(73) Assignee: Caterpillar Inc., Deerfield, IL (US)

(21) Appl. No.: 16/059,885

(22) Filed: Aug. 9, 2018

(51) Int. Cl. F16L 37/32; F16L 33/20; F16L 27/08; F16L 27/087

(52) U.S. Cl. CPC F16L 37/32; F16L 33/20; F16C 2361/41; F16L 27/087; F16L 27/0832

(57) ABSTRACT

A coupling device is provided. The coupling device may include a stem having a first end, a second end, a groove, and a threaded portion. A first engagement member may be disposed over the stem between the first end and second end. The first engagement member may be movable relative to the stem. An inner sealing member may be disposed in the groove. When the first engagement member is in a first position, the inner sealing member may be retained in the groove, seal against a surface of the stem, and may not be removed. When the first engagement member is in a second position, the inner sealing member may be retained in the groove, does not seal against the surface of the stem, and may be removed. The coupling device may include a washer, an outer sealing member, and a second engagement member disposed over the stem.

### TECHNICAL FIELD

The present disclosure relates generally to a coupling device included in a coupling assembly and, more particularly, to a male hydraulic coupling device, included in a hydraulic coupling assembly, having improved sealing, and sealing member serviceability.

### BACKGROUND

Swivel coupling devices facilitate swivel connections between various types of components in a machine, such as between hoses and valves, pumps, motors, and/or the like. Swivel coupling devices typically incorporate one or more mechanical gaskets (e.g., O-rings), for sealing surfaces between opposing components, and preventing leaks. During use, when one or more components swivel against another component, the O-ring may experience frictional wear, due to movement of a swiveling component relative to a non-swiveling component. The frictional wear may cause leaking and/or rupturing of the O-ring, and may require replacement of an entire hose assembly. This, in turn, leads to machine downtime and waste. Moreover, once positioned in a swivel coupling device, the O-ring becomes inaccessible for inspection and/or replacement.

One attempt at reducing the amount of wear experienced by an O-ring is disclosed in U.S. Pat. No. 3,799,589, which issued to Uni-Mist, Inc., on Mar. 26, 1974 (“the '589 patent”). Per the '589 patent, an O-ring sealing means is disposed in a channel formed between a female member and a male member of a swivel coupling. The male member is surrounded in the interior passage by a bearing means. The pressure of separation between the male and female members is exerted on the bearing means only, and is not transmitted to the sealing means.

While the bearing means disclosed by the '589 patent addresses one method of reducing the amount of wear imparted to an O-ring, a need exists for reducing wear using a fewer number of parts, providing easier access to the O-ring for serviceability, and/or overcoming other problems in the art.

### SUMMARY

According to some implementations, the present disclosure is related to a coupling device. The coupling device may comprise a stem having a first end, a second end, a groove disposed proximate to the first end, and a threaded portion disposed between the first end and the second end. The coupling device may further comprise a first engagement member disposed over the stem between the first end and second end. The first engagement member may be movable relative to the stem. The coupling device may further comprise an inner sealing member disposed in the groove. When the first engagement member is in a first position, the inner sealing member may be retained in the groove, seal against a surface of the stem, and not be removable. When the first engagement member is in a second position, the inner sealing member may be retained in the groove, not seal against the surface of the stem, and not be removable. The coupling device may further comprise a washer provided over the first engagement member, an outer sealing member provided over the first engagement member, proximate to the washer, and a second engagement member disposed over the threaded portion of the stem.

According to some implementations, the present disclosure is related to a further coupling device. The coupling device may comprise a stem having a first end and a second end, wherein a groove is defined in the stem proximate to the first end, and wherein a threaded portion is defined in the stem between the first end and the second end. A first engagement member may be disposed over the stem between the first end and the second end, wherein the first engagement member is movable relative to the threaded portion of the stem. An inner sealing member may be disposed in the groove, wherein, when the first engagement member is spaced apart from the threaded portion, the inner sealing member may be retained in the groove for sealing against the first engagement member, and wherein, when the first engagement member is disposed adjacent to the threaded portion, the inner sealing member may be removable from the groove. The coupling device may further comprise a washer provided over the first engagement member, an outer sealing member provided over the first engagement member, proximate to the washer, and a second engagement member disposed over the threaded portion of the stem.

According to some implementations, the present disclosure is related to a coupling assembly. The coupling assembly may include a coupling device and a port. The coupling device may comprise a stem having a first end, a second end, a groove disposed proximate to the first end, and a threaded portion disposed between the first end and the second end. The coupling device of the coupling assembly may further comprise a first engagement member disposed over the stem between the first end and the second end, wherein the first engagement member is movable relative to the stem. The coupling device of the coupling assembly may further comprise an inner sealing member disposed in the groove, wherein, when the first engagement member is in a first position, the inner sealing member may be retained in the groove by the first engagement member, and wherein, when the first engagement member is in a second position, the inner sealing member may be removable from the groove. The coupling device of the coupling assembly may further comprise a washer provided over the first engagement member, an outer sealing member provided over the first engagement member, proximate to the washer, and a second engagement member disposed over the threaded portion of the stem. The port may be disposed over the first end of the coupling device, wherein an inner surface of the port is configured to engage an outer surface of the first engagement member for coupling the first end of the stem to the port.

### BRIEF DESCRIPTION OF THE DRAWINGS

FIG. 1 is a diagram of an example coupling device, for use in a coupling assembly.

FIGS. 2 and 3 are diagrams of respective side and sectional views of an example coupling device, as installed in an example coupling assembly.

FIGS. 4 and 5 are diagrams of respective side and sectional views of the example coupling device, as installed in an example coupling assembly, and during an initial removal step from the coupling assembly.

FIGS. 6 and 7 are diagrams of respective side and sectional views of the example coupling device, upon removal of the coupling device from a coupling assembly.

FIGS. 8 and 9 are diagrams of respective side and sectional views of a portion of a coupling device.

### DETAILED DESCRIPTION

This disclosure relates to a coupling device and coupling assemblies. The coupling device has universal applicability to any machine utilizing fluid power transfer. The term “machine” may refer to any machine that performs an operation associated with an industry such as, for example, mining, construction, farming, transportation, robotics, or any other industry. As some examples, the machine may be a vehicle (e.g., a car, a truck, a boat, a helicopter, an airplane, etc.), a robotic machine, a backhoe loader, a cold planer, a wheel loader, a compactor, a paver, a forest machine, a forwarder, a harvester, an excavator, an industrial loader, a tractor, a dozer, or other type of mining, construction, farming, robotic, and/or transportation equipment.

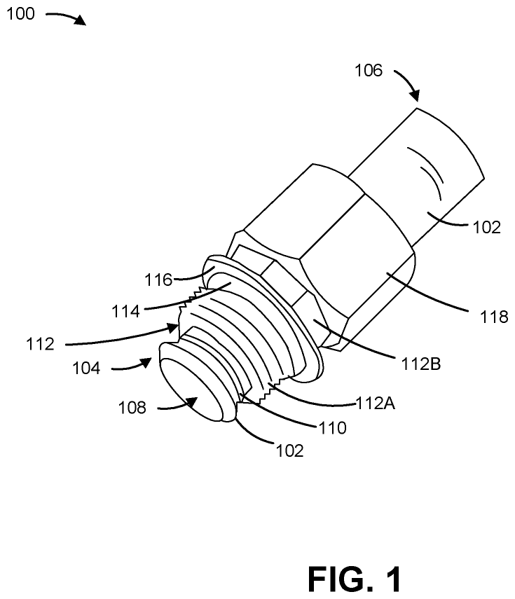

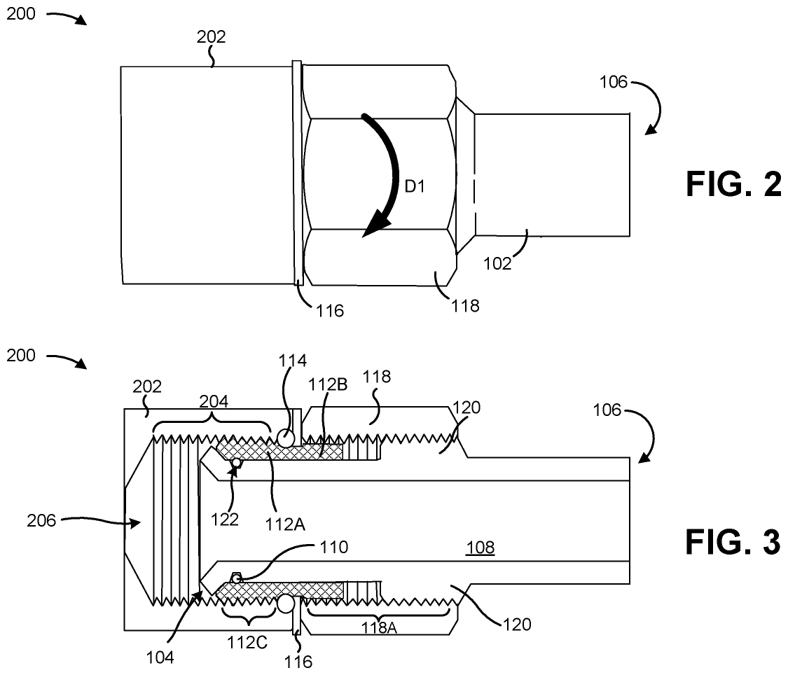

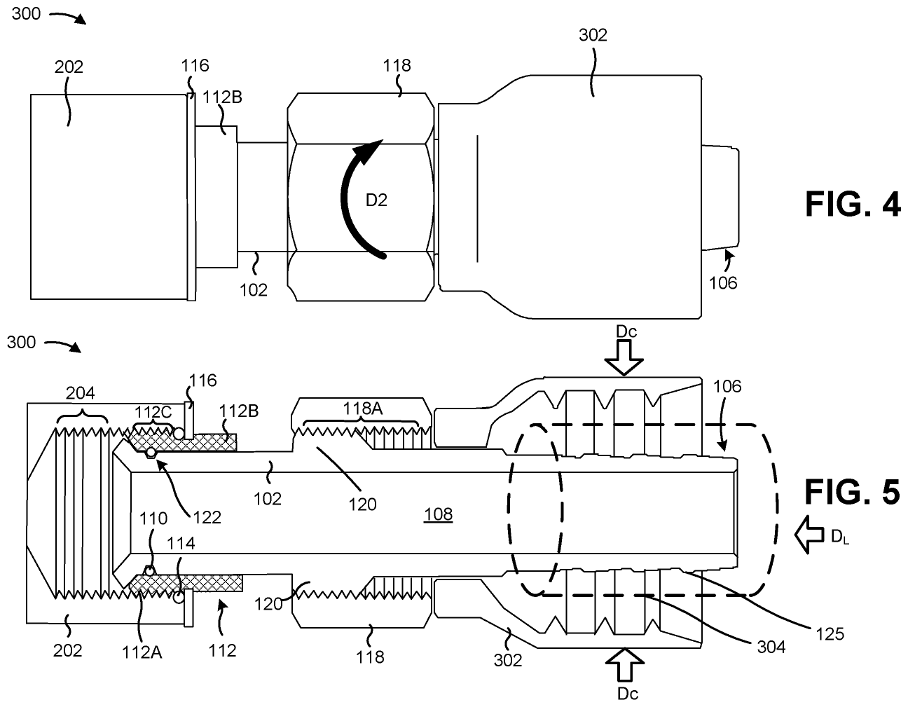

FIG. 1 is a diagram of an example coupling device, generally designated. In some implementations, coupling device 100 is configured to couple (e.g., join, connect, attach, etc.) to a fitting (see, e.g., 302, FIG. 4), whereby coupling device 100 and the fitting may collectively engage a hose (see, e.g., 304, FIG. 5), a tube, a component, conduit, and/or the like as described herein, for facilitating a fluid connection between the conduit and a port (see, e.g., 202, FIG. 2) of a hydraulic system, such as a hydraulic system including, without limitation, a motor, a pump, a generator, an accumulator, a hydraulic cylinder, and/or the like. The port may be connected to any type of system consistent with the instant disclosure.

In some implementations, coupling device 100 may include a male swivel hydraulic coupling, comprising a stem 102. Coupling device 100 and/or stem 102 may include at least a first end 104, configured for insertion in and/or coupling to a port of a hydraulic system, and a second end 106, configured for insertion in and/or coupling to a hose and/or a fitting. Stem 102 may include a hollow, bored stem body, having a passage 108 extending therethrough, by which a hydraulic fluid may pass, to provide a fluid connection between the port and the hose. Although stem 102 is illustrated as being a substantially linear, straight, or non-angled conduit, stem 102 may also be configured as an angled conduit having an angle (e.g., of about 30°, 45°, 60°, 90°, and/or the like), formed therein.

Coupling device 100 may further comprise an inner sealing member 110 disposed on, over, and/or around stem 102, and a first engagement member 112 disposed on, over, and/or around stem 102, as described herein. In some implementations, inner sealing member 110 may include an annular member, such as a single thread O-ring (e.g., an axial swivel O-ring), a gasket, and/or the like, by which faces, spaces, and/or surfaces between stem 102 and first engagement member 112 may be sealed, for improved sealing of hydraulic fluid in the coupling devices and assemblies described herein. Sealing member 110 may also seal against surfaces of stem 102 and/or first engagement member 112, when covered by first engagement member. Inner sealing member 110 may be unsealed from surfaces of stem 102 and/or first engagement member 112 when uncovered, as described herein.

In some implementations, first engagement member 112 may include a threaded portion 112A (e.g., an annular portion having external threads), by which stem 102 may be engaged and/or aligned in relation to a port, and a non-threaded portion 112B (e.g., an annular portion having a hexagonal shape), by which first engagement member 112 may be tightened and/or loosened in relation to the port. For example, first engagement member 112 may include an internal swivel nut configured to engage, retain, and/or position stem 102 relative to the port. In some implementations, first engagement member 112 may be movable relative to stem 102 and/or inner sealing member 110, for exposing inner sealing member 110 along an outer surface of stem 102, and permitting the inspection, removal, and/or replacement of inner sealing member 110.

Coupling device 100 may further comprise an outer sealing member 114, a load distributing member 116, and/or a second engagement member 118, disposed on, over, and/or around stem 102, as described herein. In some implementations, outer sealing member 114 may include single thread mechanical gasket (e.g., a single thread O-ring) configured to seal faces, spaces, and/or surfaces disposed between stem 102, first engagement member 112, and/or the port, upon compression of outer sealing member 114, by load distributing member 116 and/or second engagement member 118. As an example, load distributing member 116 may include a washer configured to compress outer sealing member 114 for forming a seal between stem 102 and the port, during rotation of second engagement member 118 and application of a sealing torque to second engagement member 118. In some implementations, inner sealing member 110 comprises a smaller diameter than the outer sealing member 114. That is, in some implementations, inner sealing member 110 comprise an inner, or outer (i.e., overall) diameter that is smaller than an inner and/or outer diameter of outer sealing member 114.

As indicated above, FIG. 1 is provided as an example. FIG. 1, as shown and described herein is not intended to be limiting, but is intended to be illustrative of the coupling devices and assemblies in which the implementations described herein may be employed.

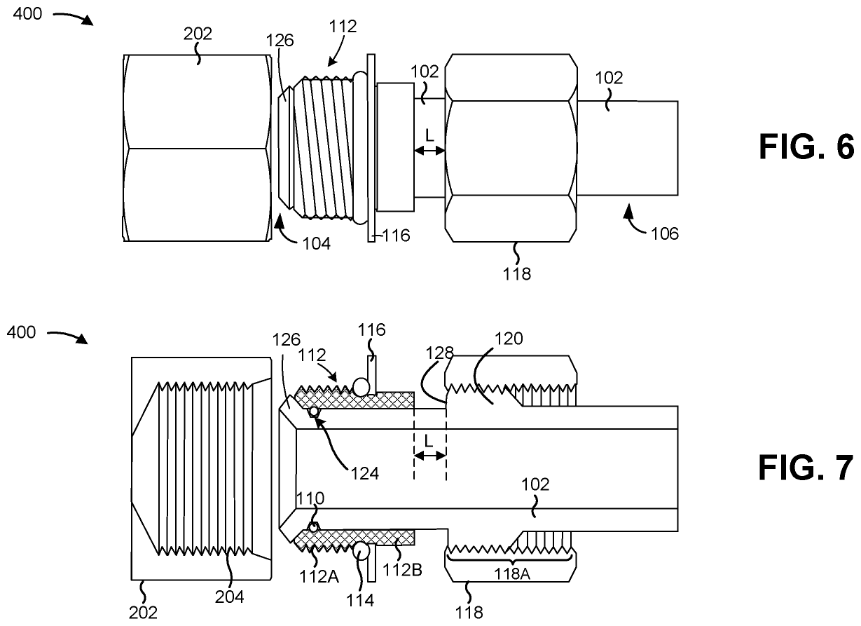

FIGS. 2 and 3 are diagrams of respective side and sectional views of an example coupling assembly, generally designated 200, including coupling device 100, provided in an installed position relative to a port 202. As FIGS. 2 and 3 illustrate, first end 104 of coupling device 100 is configured for insertion in and/or coupling to port 202, and second end 106 of coupling device 100 is configured for insertion in and/or coupling to portions of fitting (see, e.g., 302, FIG. 4) and a hose (see e.g., 304, FIG. 6).

As shown in FIG. 3, and in some implementations, coupling device 100 comprises a threaded portion 120 defined or formed therein, to which second engagement member 118 may threadingly engage for securing coupling device 100 to port 202. In some implementations, second engagement member 118 includes an external swivel nut, by which the connection between coupling device 100 and port 202 may be sealed or unsealed during rotational movement of second engagement member 118 relative to threaded portion 120 of stem 102. For example, second engagement member 118 may move in a direction towards port 202 for sealing coupling assembly 200, and in a direction away from port 202 for unsealing coupling assembly 200. Threaded portion 120 of stem 102 may be disposed between first end 104 and second end 106 of stem 102, in some implementations.

In some implementations, in the installed position, second engagement member 118 may be torqued, for example, so that second engagement member 118 rotates in a first direction of rotation D1, for moving second engagement member 118 towards port 202. During rotation of second engagement member 118, inner threads 118A of second engagement member 118 may threadingly engage threaded portion 120 of stem 102, for compressing load distributing member 116 against outer sealing member 114, and for compressing outer sealing member 114 between port 202 and coupling device 100. In this way, second engagement member 118 may facilitate formation of a sealed connection between coupling device 100 and port 202. In this way, second engagement member 118 may maintain coupling device 100 in a substantially static position relative to port 202, for reducing an amount of swivel and, thus, reducing an amount of friction and/or wear by or between surfaces and/or components of coupling device 100 and port 202. In some implementations, outer sealing member 114 and load distributing member 116 may be disposed in a lip, a groove, or a channel of first engagement member 112, whereby outer sealing member 114 and load distributing member 116 may be maintained in a desired position or location relative to coupling device 100.

In some implementations, stem 102 is configured to be secured and/or retained in a receiving end of port 202 during operation. For example, as FIG. 3 illustrates, threaded portion 112A of first engagement member 112 may include a threaded outer surface 112C configured to threadingly engage an inner threaded port surface 204. In this way, stem 102 may be provided and maintained in a desired position (e.g., an axially aligned position), with respect to port 202, and provided and maintained in a fluid connection with respect to a port inlet/outlet 206 and/or a hose conduit, as described herein.

Referring to FIG. 3, and in some implementations, coupling device 100 may further comprise a channel, slot, or groove 124 disposed proximate to first end 104 of stem 102. Groove 124 may be formed or defined in stem 102 by way of machining, cutting, etching, and/or the like, for use in retaining inner sealing member 110. As described herein, inner sealing member 110 may be exposed within groove 124 by moving (e.g., sliding, twisting, rotating, swiveling, and/or the like) first engagement member 112 relative to stem. In this way, inner sealing member 110 may be inspected, serviced, removed, and/or replaced.

As indicated above, FIGS. 2 and 3 are provided as an example. Other examples are possible and may differ from what was shown and described in connection with FIGS. 2 and 3. FIGS. 2 and 3, as shown and described herein, are not intended to be limiting, but are intended to be illustrative of devices and assemblies in which the implementations described herein may be employed.

FIGS. 4 and 5 are diagrams of respective side and sectional views of an example coupling assembly 300, as shown during an initial removal phase of coupling device 100 from coupling assembly 300. As FIGS. 4 and 5 illustrate, coupling device 100 may be provided between port 202 and a fitting 302, the fitting 302 being configured to secure or connect a hose 304 to an outer surface of stem 102. For illustration purposes, hose 304 is shown in broken lines to illustrate one possible placement thereof. Further, coupling device 100 may be connected to other components, other than a hose, for example, to a tube, another coupling component, another port, and/or the like, consistent with the instant disclosure.

As FIGS. 4 and 5 illustrate, second engagement member 118 may be rotated in a second direction of rotation D2 (e.g., opposite the first direction of rotation D1, FIG. 1), for unseating and/or unsealing coupling device 100 from port 202. For example, a portion of inner threads 118A of second engagement member 118 may, during rotation in second direction of rotation D2, unthread from threaded portion 120 of stem 102 to loosen the connection between coupling device 100 and port 202. As second engagement member 118 moves a greater distance away from port 202, load distributing member 116 may decompress from outer sealing member 114, and outer sealing member 114 may decompress from portions of port 202 and coupling device 100. As FIG. 5 illustrates, coupling device 100 may be removed or withdrawn from an interior of port 202, by unthreading threaded portion 112A, of first engagement member 112, from inner threaded port surface 204 of port 202.

As FIGS. 4 and 5 further illustrate, in some implementations, fitting 302 may be physically or mechanically fitted on, over, and/or around coupling device 100, or portions thereof, for facilitating a swivel or a non-swivel connection between hose 304 and coupling device 100. For example, in some implementations, fitting 302 may be joined to coupling device 100 via crimping, rolling, swaging, welding, and/or the like. In some implementations, fitting may include a shell or outer body member, by which hose 304 may be retained on or over the coupling device 100, and a necked down region, by which fitting 302 may attach to coupling device 100 by way of crimping, rolling, swaging, welding, and/or the like.

As further shown by FIG. 5, hose 304 may be positioned or moved in a substantially linear direction D_{L}, towards second end 106 of stem 102, for installation over stem 102. Hose 304 may be retained on or over a texturized, or barbed, outer surface 125 of stem 102. In some implementations, hose 304 may be retained over outer surface 125 of stem 102 upon compression of fitting 302 in a direction of compression D_{C}, towards or against hose 304 and/or towards or against stem 102 once hose 304 its fitted over stem 102. In this way, hose 304 may be secured in the space between outer surface 125 of stem 102 and an inner surface of fitting 302. For example, fitting 302 may include a skive ferrule, a non-skive ferrule, and/or the like, by which fitting 302 may secure hose 304 against stem 102. In some implementations, second end 106 of stem 102 is configured to taper inwardly, for improving the ease of installation of hose 304 over stem 102. In some implementations, hose 304 includes a reinforced hydraulic hose for transporting a hydraulic fluid.

As indicated above, FIGS. 4 and 5 are provided as an example. Other examples are possible and may differ from what was shown and described in connection with FIGS. 4 and 5. FIGS. 4 and 5, as shown and described herein, are not intended to be limiting, but are intended to be illustrative of devices and assemblies in which the implementations described herein may be employed.

FIGS. 6 and 7 are diagrams of respective side and sectional views of an example coupling assembly 400, upon removal of coupling device 100 from coupling assembly 400. As FIGS. 6 and 7 illustrate, first end 104 of coupling device 100 may be fully unthreaded from an interior of port 202, for disconnection, withdrawal, and removal from port 202. Upon removal of coupling device 100 from port 202, second engagement member 118 may be in a fully retracted position relative to first end 104 of coupling device 100, and may optionally be seated or abutted against a necked down region of a fitting (see e.g., 302, FIG. 5), where used.

As FIGS. 6 and 7 further illustrate, first end 104 of coupling device 100 may include a flared opening 126. Flared opening 126 may facilitate improved fluid intake, improved retention of first engagement member 112 to coupling device 100, and/or provide a metal-to-metal seal between stem 102 and first engagement member 112. In some implementations, first engagement member 112, outer sealing member 114, and load distributing member 116 may be installed over stem 102, upon which the opening of stem 102 may be flared. Flared opening 126 may assist in retaining first engagement member 112 against stem 102 during shipping, and further assist in retaining first engagement member 112 against stem 102 during application of torque and/or hydraulic pressure.

Still referring to FIGS. 6 and 7, in some implementations, first engagement member 112 may be disposed on, over, and/or cover portions of inner sealing member 110. In some implementations, inner sealing member 110 may be covered by first engagement member 112 during operation of coupling assembly 400, for example, where coupling device 100 is connected or installed to port 202 (see, e.g., FIGS. 2-5). Inner sealing member 110 may be covered by first engagement member 112 upon removal of coupling device 100 from port 202, as shown in FIGS. 6 and 7. In some implementations, first engagement member 112 may be movable on or over portions (e.g., unthreaded portions) of stem 102, for moving away from and uncovering inner sealing member 110. In this way, inner sealing member 110 may be exposed, by which inner sealing member 110 may be inspected, serviced, removed, and/or replaced. In some implementations, first engagement member 112 may be slidable over a portion of stem 102, for example, between flared opening 126 and threaded portion 120 of stem 102.

As FIGS. 6 and 7 further illustrate, first engagement member 112 may be slidable a distance or a length L over stem 102, proximally or distally relative to second end 106 of stem 102, threaded portion 120 of stem 102, and/or flared opening 126 of stem 102. When in a first position, first engagement member 112 may be disposed proximate to first end 104 of stem, and optionally contact flared opening 126. In the first position, first engagement member 112 may cover inner sealing member 110. When in a second position, first engagement member 112 may traverse the length L of stem 102, and be disposed proximate to threaded portion 120 of stem 102, and optionally contact, abut, and/or seat against an outer edge, face, or wall 128 of threaded portion 120. In the second position, inner sealing member 110 may be uncovered, and accessed for inspection, service, removal, replacement, and/or the like.

As indicated above, FIGS. 6 and 7 are provided as an example. Other examples are possible and may differ from what was shown and described in connection with FIGS. 6 and 7. FIGS. 6 and 7, as shown and described herein, are not intended to be limiting, but are intended to be illustrative of devices and assemblies in which the implementations described herein may be employed.

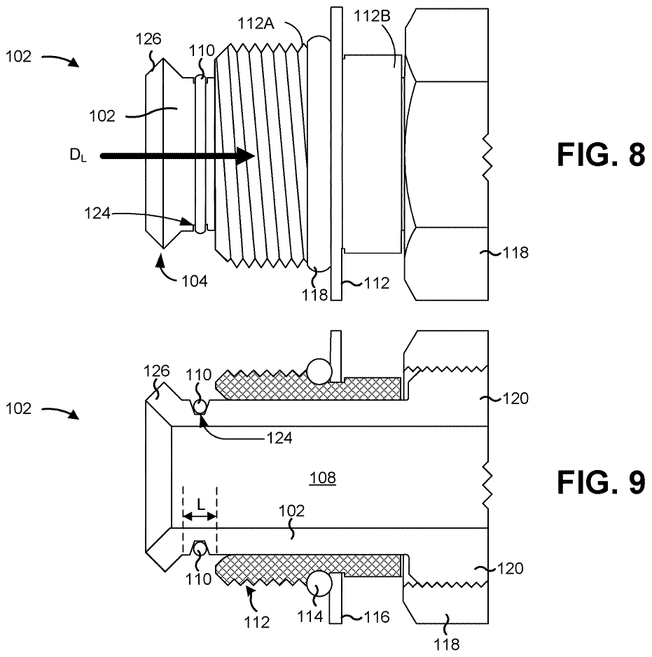

FIGS. 8 and 9 are diagrams of respective side and sectional views of a portion of coupling device 100, that may be provided or used in the coupling assemblies (e.g., 200, 300, 400) of FIGS. 1-7. In some implementations, inner sealing member 110 may be positioned in groove 124 for sealing surfaces between stem 102 and first engagement member 112, during use. As FIGS. 8 and 9 illustrate, first engagement member 112 may move in linear direction D_{L}, for example, in a direction away from flared opening 126, and towards second engagement member 118 and/or threaded portion 120, by which first engagement member 112 may traverse the length L of stem 102. As first engagement member 112 moves, inner sealing member 110 may be uncovered or exposed in groove 124, and along a surface of coupling device 100, for inspection, removal from groove 124, replacement, and/or the like. Stated differently, when first engagement member 112 is spaced apart from threaded portion 120, inner sealing member 110 may be retained by groove 124, and when first engagement member 112 is disposed adjacent to threaded portion 120, inner sealing member 110 may be removable from groove 124.

As indicated above, FIGS. 1-9 are provided as examples. Other examples are possible and may differ from what was shown and described in connection with FIGS. 1-9. In other words, the coupling assemblies, the components shown as being included in the coupling assemblies, and the arrangement of such components, are provided for illustrative purposes only. Additionally, FIGS. 1-9 do not illustrate scale representations of the coupling assemblies described herein, and/or the components shown as being included in coupling assemblies described herein. Rather, FIGS. 1-9, as shown and described herein are not intended to be limiting but are intended to be illustrative of the coupling devices and assemblies in which the implementations described herein may be employed.

### INDUSTRIAL APPLICABILITY

The disclosed coupling device 100 and coupling assemblies (e.g., 200, 300, 400), or portions thereof, may be used with any machine in which fluid power transfer is provided. In operation, coupling device 100 may be secured to coupling assemblies (e.g., 200, 300, 400) by way of one or more threaded connections. In this way, an amount of swivel between coupling device 100 and/or coupling assemblies (e.g., 200, 300, 400) may be reduced. In this way, an amount of friction and/or wear by or between surfaces and/or components of coupling device 100, and/or coupling assemblies (e.g., 200, 300, 400), may be reduced.

In some implementations, coupling device 100 includes a movable first engagement member 112, by which inner sealing member 110 may be covered during operation, and exposed upon removal of coupling device 100 from coupling assembly 200. In this way, inner sealing member 110 may be inspected for wear, serviced, removed, and/or replaced. In this way, failures associated with ruptured or failed sealing members may be mitigated or reduced. In this way, coupling devices may experience longer lifetimes by way of improved sealing, improved serviceability, and/or reduced wear.

In some implementations, coupling device 100 includes a male swivel coupling member, or stem 102, configured for insertion in a female port opposite a hose. In this way, costly and/or cumbersome adapters, which may be used to convert female swivel connections to male face-seal connections, may be obviated, or reduced. In this way, the ease of installation and manufacturability of coupling device 100 for hydraulic coupling assemblies may improve. Further, in this way, the number of parts may be reduced, the number of torqued connections may be reduced, and designs for coupling device 100 and/or coupling assemblies (e.g., 200, 300, 400) may be improved and/or simplified.

In some implementations, coupling device 100 includes flared opening 126. Flared opening 126 may facilitate improved fluid intake, improved retention of first engagement member 112 to coupling device 100, and/or provide a secondary, metal-to-metal seal between stem 102 and first engagement member 112 for improved sealing of hydraulic fluid in coupling assembly 200. In this way, hydraulic fluid leaks may be prevented, reduced, and/or mitigated.

As used herein, the articles “a” and “an” are intended to include one or more items and may be used interchangeably with “one or more.” Also, as used herein, the terms “has,” “have,” “having,” or the like are intended to be open-ended terms. Further, the phrase “based on” is intended to mean “based, at least in part, on.”

The foregoing disclosure provides illustration and description but is not intended to be exhaustive or to limit the implementations to the precise form disclosed. Modifications and variations are possible in view of the above disclosure or may be acquired from practice of the implementations. It is intended that the specification be considered as an example only, with a true scope of the disclosure being indicated by the following claims and their equivalents. Even though particular combinations of features are recited in the claims and/or disclosed in the specification, these combinations are not intended to limit the disclosure of possible implementations. Although each dependent claim listed below may directly depend on only one claim, the disclosure of possible implementations includes each dependent claim in combination with every other claim in the claim set.

What is claimed is:

1. A coupling device, comprising:
a stem comprising:
a first end;
a second end;
a groove disposed proximate to the first end; and
a threaded portion disposed between the first end and the second end;
a first engagement member disposed over the stem between the first end and second end,
wherein the first engagement member is movable relative to the stem;
an inner sealing member disposed in the groove,
wherein, when the first engagement member is in a first position, the inner sealing member is retained in the groove, seals against a surface of the stem, and is not removable, and
wherein, when the first engagement member is in a second position, the inner sealing member is retained in the groove, does not seal against the surface of the stem, and is removable;
a washer provided over the first engagement member;
an outer sealing member provided over the first engagement member, proximate to the washer; and
a second engagement member disposed over the threaded portion of the stem.

2. The coupling device of claim 1, wherein the first end comprises a flared opening.

3. The coupling device of claim 2, wherein the first engagement member is slidable between the flared opening and the threaded portion of the stem.

4. The coupling device of claim 1, wherein the first end of the stem is configured for insertion in a port.

5. The coupling device of claim 4, wherein an outer surface of the first engagement member is configured to threadingly engage an inner surface of the port for coupling the first end of the stem to the port.

6. The coupling device of claim 4, wherein the port is connected to a pump, a motor, a generator, or a hydraulic cylinder.

7. The coupling device of claim 1, wherein the second end of the stem is configured for insertion in a hose, a tube, or a component.

8. The coupling device of claim 7, wherein the second end of the stem comprises a barbed outer surface configured to retain a portion of the hose, the tube, or the component.

9. A coupling device, comprising:
a stem having a first end and a second end,
wherein a groove is defined in the stem proximate to the first end, and
wherein a threaded portion is defined in the stem between the first end and the second end;
a first engagement member disposed over the stem between the first end and the second end,
wherein the first engagement member is movable relative to the threaded portion of the stem;
an inner sealing member disposed in the groove,
wherein, when the first engagement member is spaced apart from the threaded portion, the inner sealing member is retained in the groove for sealing against the first engagement member, and
wherein, when the first engagement member is disposed adjacent to the threaded portion, the inner sealing member is removable from the groove;
a washer provided over the first engagement member;
an outer sealing member provided over the first engagement member, proximate to the washer; and
a second engagement member disposed over the threaded portion of the stem.

10. The coupling device of claim 9, wherein the first end comprises a flared opening.

11. The coupling device of claim 9, wherein the second end comprises a tapered opening.

12. The coupling device of claim 9, wherein the first engagement member is slidable on the stem.

13. The coupling device of claim 9, wherein an outer surface of the first engagement member is configured to threadingly engage an inner surface of a port for coupling the first end of the stem to the port.

14. The coupling device of claim 9, wherein the first engagement member comprises an internal swivel nut.

15. The coupling device of claim 9, wherein the second engagement member comprises an external swivel nut.

16. The coupling device of claim 9, wherein the inner sealing member and the outer sealing member comprise single thread O-rings, and
wherein the inner sealing member comprises a smaller diameter than the outer sealing member.

17. A coupling assembly, comprising:
a coupling device, comprising:
a stem comprising:
a first end;
a second end;
a groove disposed proximate to the first end; and
a threaded portion disposed between the first end and the second end;
a first engagement member disposed over the stem between the first end and the second end,
wherein the first engagement member is movable relative to the stem;
an inner sealing member disposed in the groove,
wherein, when the first engagement member is in a first position, the inner sealing member is retained in the groove by the first engagement member, and
wherein, when the first engagement member is in a second position, the inner sealing member is removable from the groove;
a washer provided over the first engagement member;
an outer sealing member provided over the first engagement member, proximate to the washer;
a second engagement member disposed over the threaded portion of the stem; and
a port disposed over the first end of the coupling device,
wherein an inner surface of the port is configured to engage an outer surface of the first engagement member for coupling the first end of the stem to the port.

18. The coupling assembly of claim 17, wherein the port is connected to a pump, a motor, a generator, or a hydraulic cylinder.

19. The coupling assembly of claim 17, wherein the outer sealing member is disposed between portions of the port and the coupling device, and
wherein the outer sealing member is configured to seal a space between the port and the coupling device upon threading the second engagement member against the threaded portion.

20. The coupling assembly of claim 17, further comprising:
a hose disposed over the second end of the coupling device; and
a fitting disposed over the hose,
wherein the fitting is configured to compress the hose against the second end of the coupling device for coupling the hose to the coupling device.
